(19) United States
(12) Patent Application Publication
(10) Pub. No.: US 2016/0097838 A1
(43) Pub. Date: Apr. 7, 2016

(54) PORTABLE SOUND SOURCE SEARCHING SENSOR AND METHOD OF MANUFACTURING THE SAME

(71) Applicant: SM INSTRUMENTS CO., LTD, Yuseong-gu Daejeon (KR)

(72) Inventor: YoungKi KIM, Daejeon (KR)

(73) Assignee: SM INSTRUMENT CO., LTD., Yuseong-gu, Daejeon (KR)

(21) Appl. No.: 14/358,005

(22) PCT Filed: Sep. 2, 2013
(86) PCT No.: PCT/KR2013/007874

§ 371 Date: May 13, 2014

(30) Foreign Application Priority Data
Jun. 21, 2013 (KR) 10-2013-0071285

(51) Int. Cl. G01S 5/18; H04R 3/00; H04R 19/04; H04R 31/00

(52) U.S. Cl. CPC G01S 5/18; H04R 31/00; H04R 3/005; H04R 19/04; H04R 2499/11

(57) ABSTRACT

A portable sound source searching sensor comprising: a front body (10) in which acoustic sensors of MEMS microphones (20) are arranged to face forward; MEMS microphones (20) of which acoustic sensors are exposed to the front body (10) in a fixed state to the substrate (30); a substrate (30) on which the microphones (20) are mounted; an image photographing unit (40) of which a photographing lens (41) is exposed through a lens hole of the front body (10); and a rear body (50) for surrounding a rear side of the substrate (30) and a rear side of the image photographing unit in a state that the substrate (30) is positioned at a rear side of the front body (10).

### BACKGROUND OF THE INVENTION

1. Field of the Invention

Exemplary embodiments of the present invention relates to a portable acoustic camera for using MEMS microphones and method of manufacturing the same.

2. Description of Related Art

An acoustic camera is an ultramodern measurement apparatus for visualizing sound, and a new technology device which is necessary in various fields such as multimedia information devices, household electrical appliances, automobiles, construction, etc. The applicant of the present invention, SM instruments Inc. and the KAIST are the one that have leading technologies in the acoustic camera for using the existing measurement microphone and have made common products.

Korean Registration patent number No. 10-051120 of ‘Korean Advanced Institute of Science and Technology’ is a method of separating sound filed of the separate sound source by using acoustic holograph, as a method of separating sound field of sound source for using acoustic holography, comprises a first step for measuring sound pressure at several points on hologram and for obtaining hologram spectrum matrix which comprises self spectrum of sound pressure at each point and mutual spectrum between other points; a second step of applying the hologram surface spectrum matrix to the acoustic holography method and calculating a sound source surface spectrum matrix which comprises a self spectrum of sound pressure value at each point and a mutual spectrum between other points; a third step of determining as a position of sound source a position where the self spectrum of sound pressure value is a maximum in the sound source surface spectrum matrix, and calculating contribution amount of the determined sound source, and a fourth step of renewing, if there is a remaining spectrum matrix which is a subtract of contribution amount of the determined sound source from the sound source surface spectrum matrix, the remaining spectrum matrix to a new sound source surface spectrum matrix and repeating its performance from the third step.

### SUMMARY OF THE INVENTION

An object of the present invention is to provide a sound source searching sensor for improving greatly the existing acoustic camera by using MEMS microphones, and for improving manufacture period and costs by making MEMS microphones in the type of print circuit board.

In addition, an object of the present invention is to provide a portable sound source searching sensor for improving removal of reflection wave by blocking front/rear sound, and producing a new market with the acoustic camera of becoming a popular measurement apparatus. Another object is to provide a portable sound source searching sensor which is easy to use and mounting and easy to moving and fixing.

In addition, the present invention is to provide a portable sound source searching sensor further comprising a handle, without a fixing means, wherein the positioning can be made when a user holds the camera in any place or puts it on any table.

To obtain the above objects, the portable acoustic camera of the present invention comprises a front body 10 in which acoustic sensors of MEMS microphones 20 are arranged to face forward; MEMS microphones 20 of which acoustic sensors are exposed to the front body 10 in a fixed state to the substrate 30; a substrate 30 on which the microphones 20 are mounted; an image photographing unit 40 of which a photographing lens 41 is exposed through a lens hole of the front body 10; and a rear body 50 for surrounding a rear side of the substrate 30 and a rear side of the image photographing unit in a state that the substrate 30 is positioned at a rear side of the front body 10.

### BRIEF DESCRIPTION OF THE DRAWINGS

FIG. 1 is a perspective view of a portable sound source searching sensor of an embodiment of the present invention.

FIGS. 2a and 2b are front views of the portable sound source searching sensor of the embodiment of the present invention.

FIG. 3 is a rear view of the portable sound source searching sensor of the embodiment of the present invention.

FIG. 4 is a rear view of the portable sound source searching sensor of the embodiment of the present invention, without the rear body.

FIG. 5 is a bottom view of the portable sound source searching sensor of the embodiment of the present invention, without the rear body.

FIGS. 6a and 6b are front and rear views of the front body for describing the method of manufacturing the portable sound source searching sensor of the embodiment of the present invention.

FIGS. 7a and 7b are front and rear views of the rear body for describing the method of manufacturing the portable sound source searching sensor of the embodiment of the present invention.

FIGS. 8a and 8b are views of a rear inner plate for describing the method of manufacturing the portable sound source searching sensor of the embodiment of the present invention.

FIG. 9 is a detail view of an image photographing unit and DAB of the embodiment of the present invention.

FIG. 10 is an explosion view of showing a handle.

FIG. 11 is a detail view of a hollow fixing piece of the embodiment of the present invention.

FIG. 12 is a flow chart of describing a method of manufacturing the portable sound source searching sensor according to the embodiment of the present invention.

### DETAILED DESCRIPTION OF THE INVENTION

The portable acoustic camera of the present invention comprises a front body 10 in which acoustic sensors of MEMS microphones 20 are arranged to face forward; MEMS microphones 20 of which acoustic sensors are exposed to the front body 10 in a fixed state to the substrate 30; a substrate 30 on which the microphones 20 are mounted; an image photographing unit 40 of which a photographing lens 41 is exposed through a lens hole of the front body 10; and a rear body 50 for surrounding a rear side of the substrate and a rear side of the image photographing unit in a state that the substrate 30 is positioned at a rear side of the front body 10.

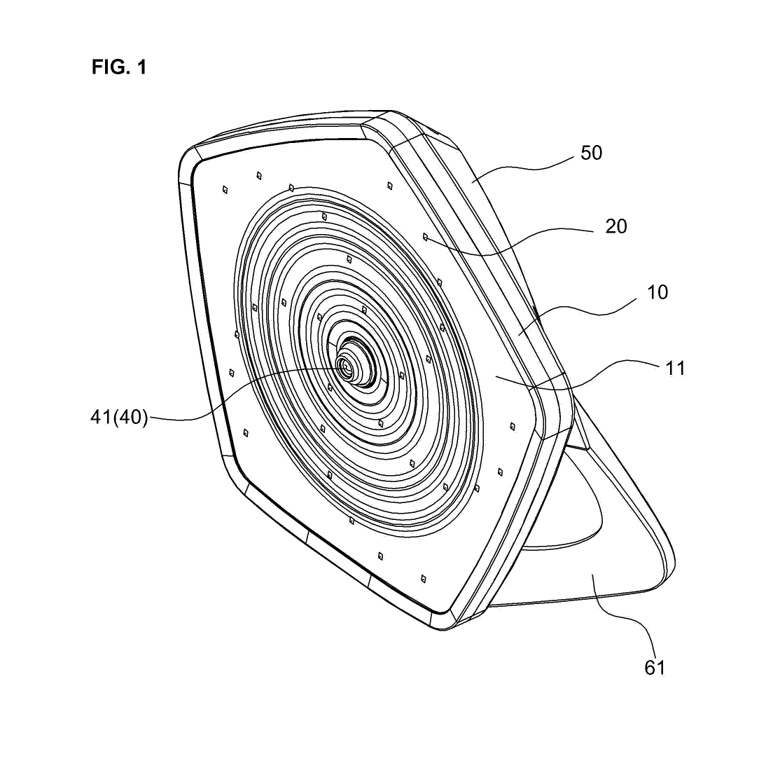

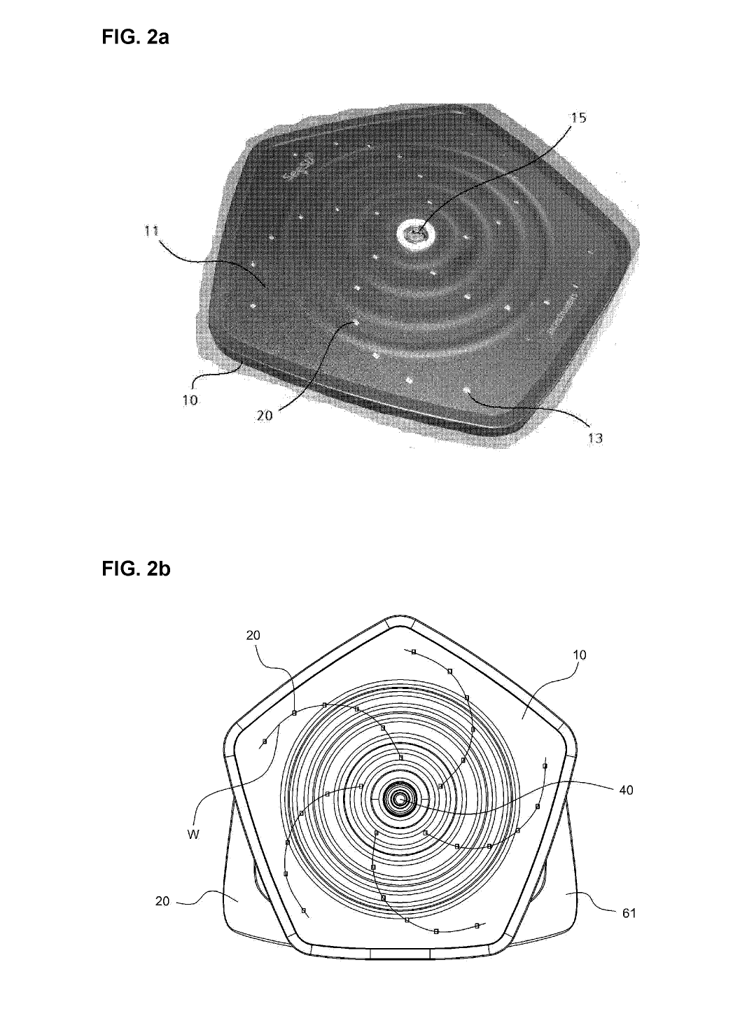

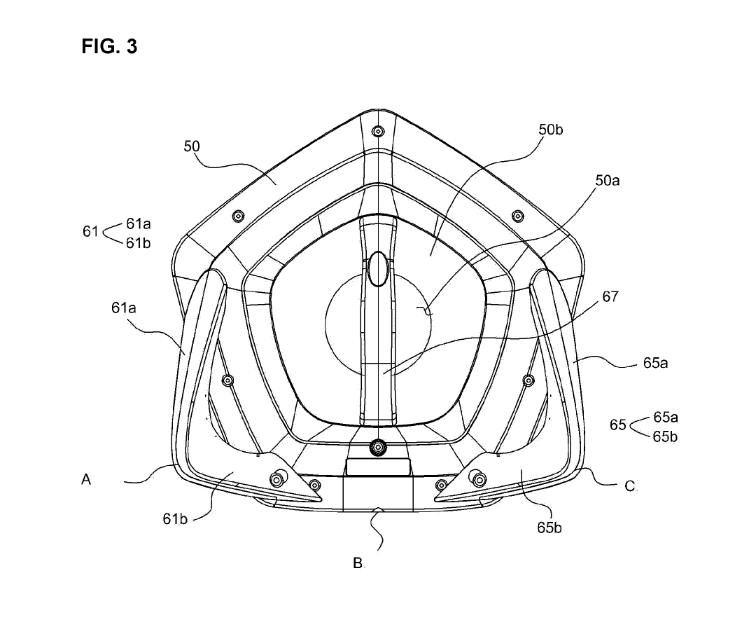

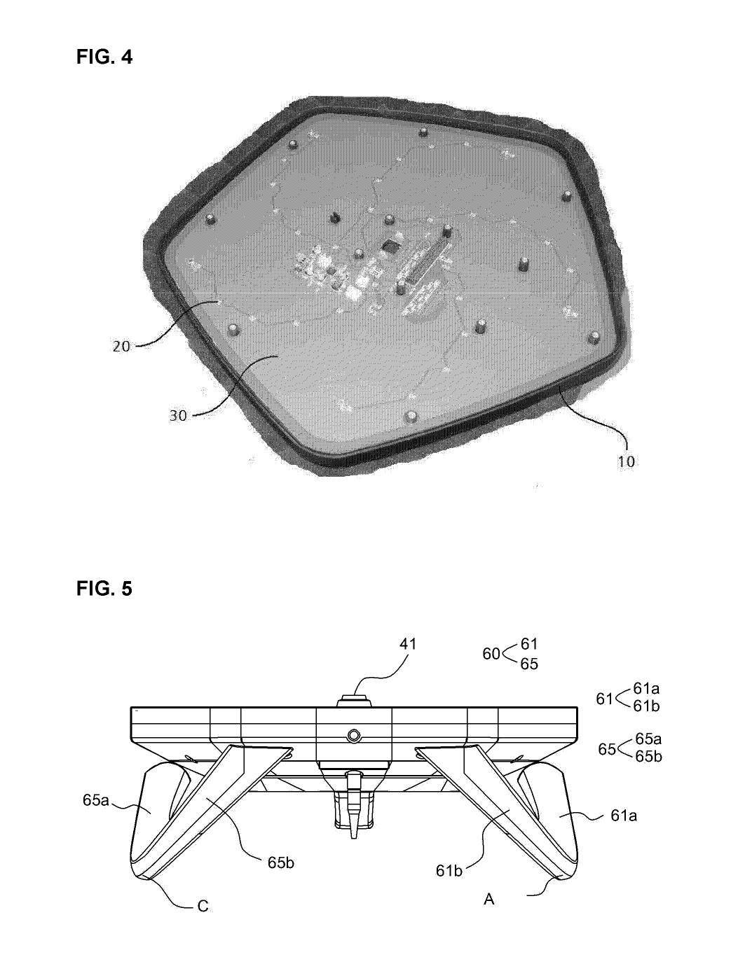

Hereinafter, a portable sound source searching sensor according to an embodiment of the present invention will be described in detail with reference to the accompanying drawings. FIG. 1 is a perspective view of a portable sound source searching sensor of an embodiment of the present invention. FIGS. 2a and 2b are front views of the portable sound source searching sensor of the embodiment of the present invention. FIG. 3 is a rear view of the portable sound source searching sensor of the embodiment of the the present invention. FIG. 4 is a rear view of the portable sound source searching sensor of the embodiment of the present invention, without the rear body. FIG. 5 is a bottom view of the portable sound source searching sensor of the embodiment of the present invention, without the rear body.

The term “exposition” in this invention does not mean projection, and it means existence of electric or physical passage through which air, sound, wave or light can move in. In this invention, the MEMS microphone is made by changing the existing microphone in a form of electronic chip in order to be used in mobile phones, etc., The term “MEMS microphone” may include all the general MEMS microphones, for example the capacitor type silicon MEMS microphone and the capacitive microphone, which is used in this invention. As the mobile phone technology develops, it has a great performance for the present, which is second to the microphone for measurement.

As shown in FIGS. 1-5, a portable sound source searching sensor of an embodiment of the present invention comprises a front body 10, MEMS microphones 20, a substrate 30, an image photographing unit 40 and a rear body 50.

As shown in FIGS. 1-5, in the front body 10, acoustic sensors of MEMS microphones 20 are arranged to face forward. The acoustic sensor of MEMS microphone is exposed in the front body 10 in a fixed state to the substrate 30.

As shown in FIGS. 1-5, on the substrate 30 are mounted the MEMS microphones 20. A photographing lens 41 of the image photographing unit 40 is exposed through a lens hole of the front body 10. The image photographing unit 40 may further comprise existing electronics (image collector, signal transformer or image signal processor) which transform image signals from the photographing lens to electronic signals.

As shown in FIGS. 1-5, a rear body 50 surrounds a rear side of the substrate 30 and a rear side of the image photographing unit 40 in a state that the substrate 30 is positioned at a rear side of the front body 10. The front body 10 and the rear body 50 have advantageous effects in the forming and weight aspect when plastic resin is used.

In the portable sound source searching sensor according to the embodiment of the present invention, the MEMS microphones 20 has 2-30 branches W which extend radially on the straight or in a spiral shape, and the 2-50 MEMS microphones 20 may be arranged in the branch W.

The portable sound source searching sensor according to the embodiment of the present invention, as shown in figures, preferably further comprises handle 60 which is projected backward in a fixed state to an edge of the front body 10 or the rear body 50. The handle 60 preferably comprises a pair of left and right handle 61,65 which are formed symmetrically.

In the portable sound source searching sensor of the embodiment of the present invention, as shown in figures, the left, right handle 61,65 preferably comprises a first, second upper lengthwise bar 61a,65a of which upper ends are fixed to the rear body 50 and lower ends are coupled to rear ends of the first, second lower crosswise bar 61a, 65a; and the first, second lower crosswise bar 61b, 65b of which front ends are fixed to the rear body 50 and the rear ends are coupled to the lower ends of the first, second upper lengthwise bar 61a, 65a.

In the portable sound source searching sensor of the embodiment of the present invention, as shown in figures, a point A of a lower outline of the front body 10 or the rear body 50, or a lower outline, a lower support point B of the left handle 61 and a lower support point C of the right handle 65 form a plane so that an acoustic camera can be supported by a structure on a plane.

The acoustic camera of the embodiment of the present invention, as shown in figures, further comprises a central handle 67 which extends upward and downward between the left, right handle 61, 65. As shown in FIG. 3, an incline is formed in a back center of the rear body 50 and a bottom groove 50a is formed concave. It is preferable that an inner side of the central handle 67 faces the bottom groove 50a.

In the acoustic camera of the embodiment of the present invention, as shown in figures, the front body 10 and the rear body 50 are made by plastic injection, and the left, right handle 61,65 and the central handle 67 are assembled to the rear body 50 by a coupling means. The front body 10 includes a front plate 11 which forms a plane, and the front plate 11 and the substrate 30 are preferably arranged parallel.

In the acoustic camera of the embodiment of the present invention, as shown in figures, the photographing lens 41 is exposed through a lens hole 15 which is formed in a central deep part of the front plate 11. The acoustic sensors of the MEMS microphones 20 are preferably exposed through the plural of sensing holes 13 which are formed in the front plate 11.

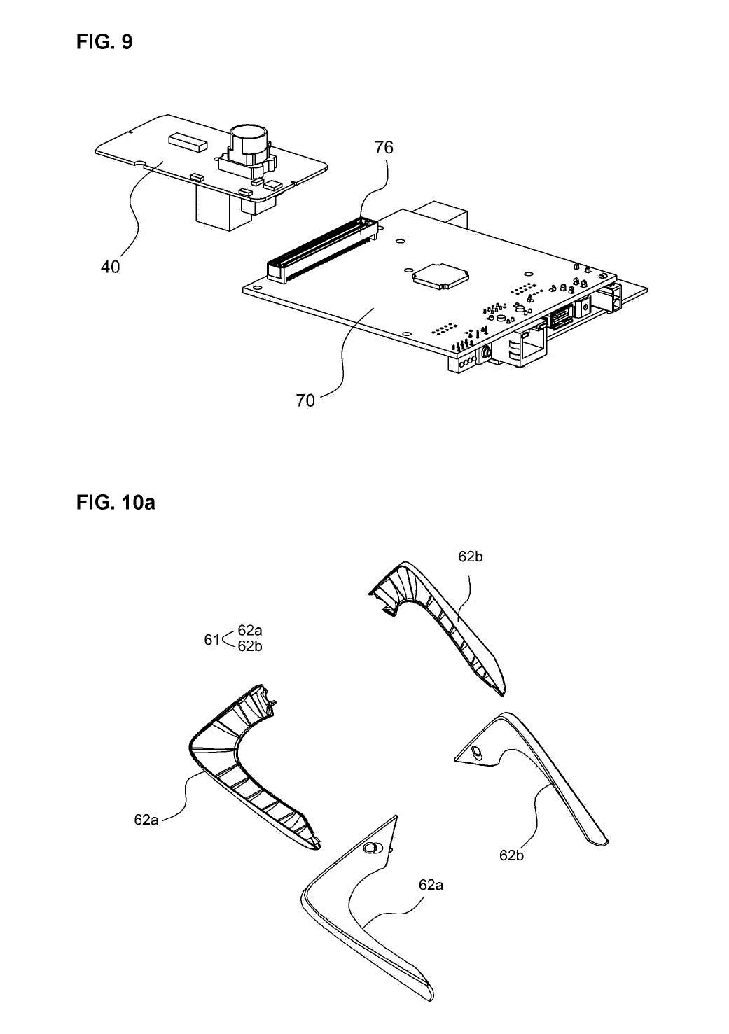

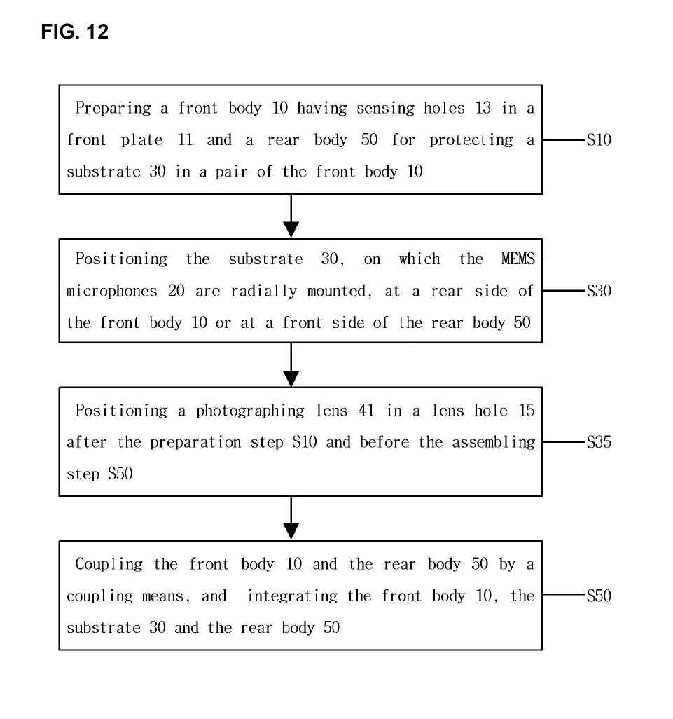

As shown in FIG. 1-FIG. 12, in a step of positioning the substrate S30, the substrate 30, on which the MEMS microphones 20 are radially mounted, is positioned at a rear side of the front body 10 or at a front side of the rear body 50.

Subsequently, in an assembling step S50, the front body 10 and the rear body 50 are coupled by a coupling means, and the front body 10, the substrate 30 and the rear body 50 are integrated.

As shown in FIG. 1-FIG. 12, the method of manufacturing the portable sound source searching sensor of the present invention, after a preparation step S10 and before the assembling step S50 may further comprise a step of positioning photographing lens S 35 where a photographing lens 41 is positioned in a lens hole 15 after the preparation step S10 and before the assembling step S50.

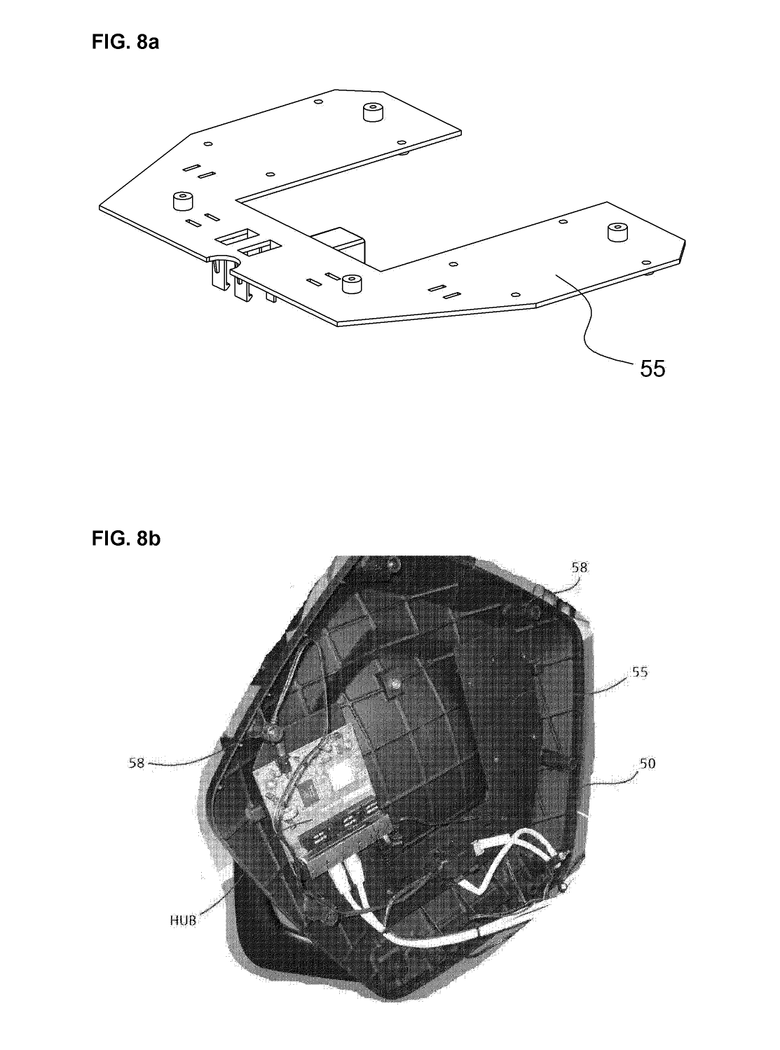

As shown in FIG. 1-FIG. 12 (specially, FIG. 8), in the method of manufacturing the portable sound source searching sensor of the present invention, a front plane of the rear body 50 is curved, and a flat rear inner plate 55 is coupled thereto.

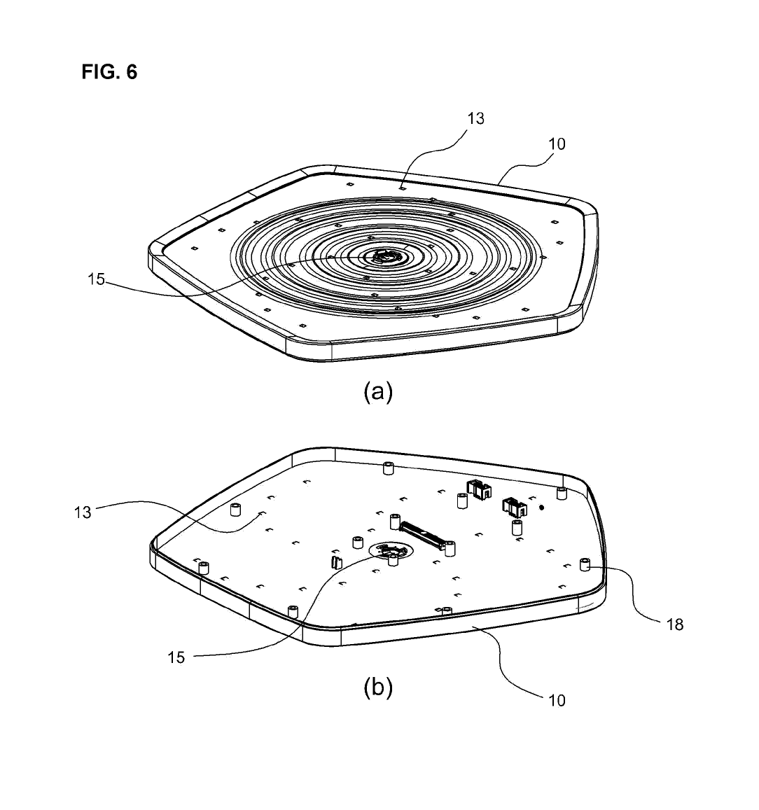

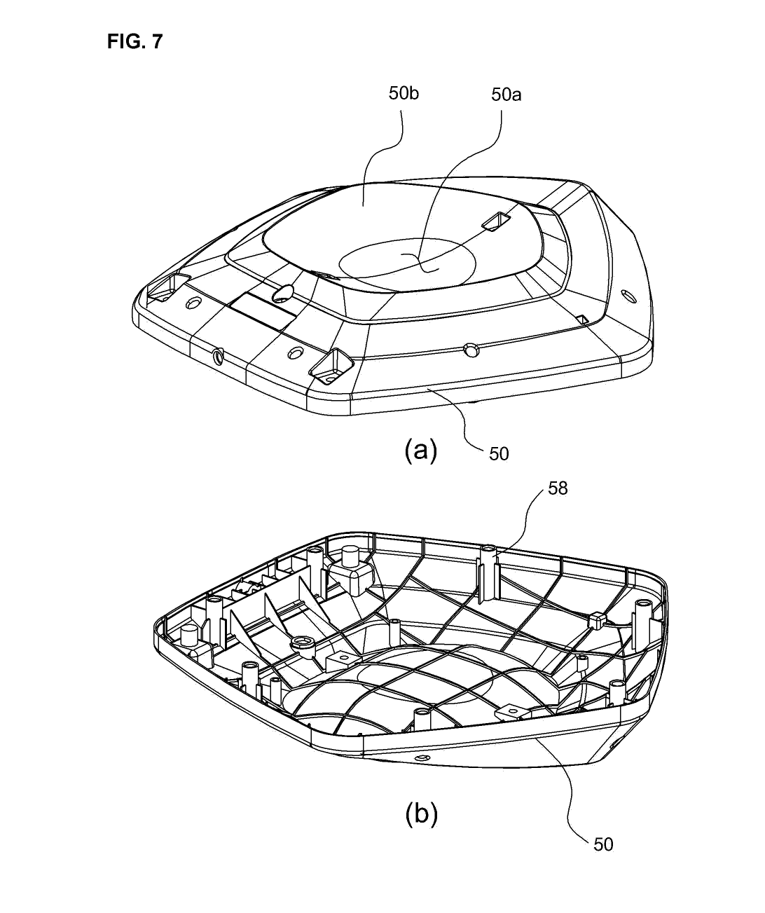

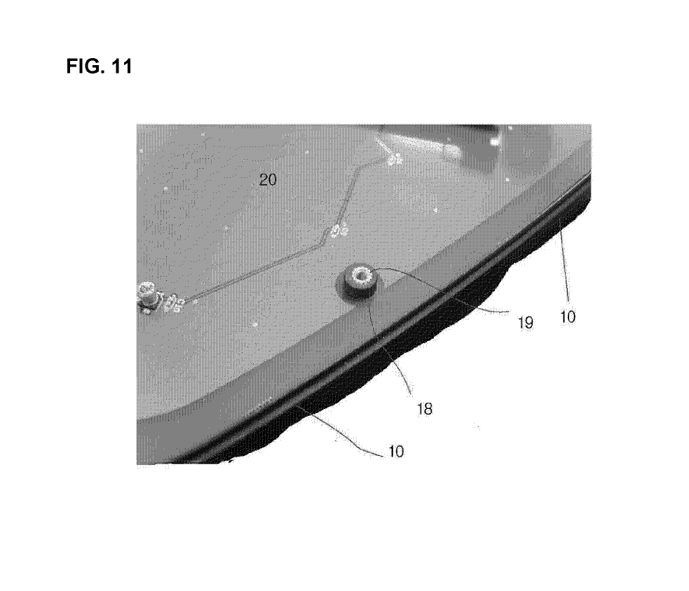

As shown in FIG. 1-FIG. 12 (specially, FIG. 6, FIG. 7 and FIG. 11), in the method of manufacturing the portable sound source searching sensor of the embodiment, first hollow fixing pieces 18 are projected at a rear side of the front body 10, and second fixing pieces 58 are projected at a front side of the rear body 50, a coupling means tighten the first hollow fixing pieces 18 and the second hollow fixing pieces 58 to integrate the front body 10 and the rear body 50.

As shown in FIG. 1-FIG. 12 (specially, FIG. 6, FIG. 7 and FIG. 11), in the method of manufacturing the portable sound source searching sensor of the embodiment, a metal piece 19, which a spiral is formed on an inner circumferential surface is pressed and fixed in a hollow of the first hollow fixing pieces 18, and the coupling means is a bolt or screw which penetrate the second hollow fixing pieces 58.

As shown in FIG. 1-FIG. 12, the method of manufacturing the portable sound source searching sensor of the embodiment further comprises a step S40 of positioning the image photographing unit 40 which processes image signal from the photographing lens 41 at a rear of the substrate 30 after the step of positioning the photographing lens S35 before the step of assembling S50; a step of electronically connecting S45 the substrate 30 and a data acquisition board 70 for acquiring acoustic signal from the MEMS microphones 20 to pass it to a calculating unit.

The method of manufacturing the portable sound source searching sensor of the embodiment further comprises a step of mounting a handle 60 which is projected backward of the rear body 50, wherein the handle 60 is assembled from the start to a rear of the rear body 50 in the preparation step S10, or the handle 60 is coupled to edge of the front body 10 or a rear side of the rear body 50 after the assembling step S50.

As shown in FIG. 10, the handle 61,65 is injection molded and formed to two pieces 62a, 62b and thereafter two pieces are bonding-coupled in a pair, and the coupling part is grinded to have smooth appearance as shown in FIG. 10.

As describing above, the present invention provides a sound source searching sensor for improving greatly the existing acoustic camera by MEMS microphones, and for improving manufacture period and costs by making MEMS microphones in the type of print circuit board. In addition, the present invention provides a portable sound source searching sensor for improving removal of reflection wave by blocking front/rear sound, and producing a new market with the acoustic camera of becoming a popular measurement apparatus. In addition, the present invention provides a portable sound source searching sensor which is easy to use and mounting and easy to moving and fixing. In addition, the present invention provides a portable sound source searching sensor comprising a handle, without a fixing means, wherein the positioning can be made when a user holds the camera in any place or put on any table.

While the present invention has been described with respect to the specific embodiments, it will be apparent to those skilled in the art that various changes and modifications may be made without departing from the spirit and scope of the invention as defined in the following claims.

Reference numbers in following claims is only for helping understanding of the invention, and the reference numbers does not affect interpretation of scope of claims, and claim scope should not be interpreted in a narrow sense by the reference numbers.

What is claimed is:

1. A portable sound source searching sensor comprising:
a front body (10) in which acoustic sensors of MEMS microphones (20) are arranged to face forward;
MEMS microphones (20) of which acoustic sensors are exposed to the front body (10) in a fixed state to the substrate 30;
a substrate (30) on which the microphones (20) are mounted;
an image photographing unit (40) of which a photographing lens (41) is exposed through a lens hole of the front body (10); and
a rear body (50) for surrounding a rear side of the substrate (30) and a rear side of the image photographing unit in a state that the substrate (30) is positioned at a rear side of the front body (10).

2. The sensor in claim 1, wherein the MEMS microphones (20) has 2-30 branches W which extend radially on the straight or in a curved or spiral shape, and the 2-50 MEMS microphones (20) may be arranged in the branch W.

3. The sensor of claim 1 further comprising a handle (60) which is projected backward in a fixed state to an edge of the front body (10) or the rear body (50).

4. The sensor of claim 2, wherein the handle (60) comprises a pair of left and right handle (61,65) which are formed symmetrically.

5. The sensor of claim 4, wherein the left, right handle (61,65) comprises:
a first, second upper lengthwise bar (61a,65a) of which upper ends are fixed to the rear body (50), and lower ends are coupled to rear ends of the first, second lower crosswise bar (61a, 65a); and
the first, second lower crosswise bar (61b, 65b) of which front ends are fixed to the rear body (50), and the rear ends are coupled to the lower ends of the first, second upper lengthwise bar (61a, 65a).

6. The sensor of claim 5, wherein a point A of a lower outline of the front body (10) or the rear body (50), or a lower outline; a lower support point B of the left handle (61); and a lower support point C of the right handle 65 form a plane
so that a sound source searching sensor can be supported by a structure on a plane.

7. The sensor of claim 1 further comprising a central handle (67) which extends up- and downward between the left, right handle (61,65).

8. The sensor of claim 7, wherein an incline is formed in a back center of the rear body (50), and a bottom groove (50a) is formed concave, and an inner side of the central handle (67) faces the bottom groove (50a).

9. The sensor of one of claims 3-7, wherein the front body (10) and the rear body (50) are made by plastic injection, and the left, right handle (61,65) and the central handle (67) are assembled to the rear body (50) by a coupling means.

10. The sensor of claim 1, wherein the front body (10) includes a front plate (11) which forms a plane, and the front plate (11) and the substrate (30) are preferably arranged parallel.

11. The sensor of claim 1, wherein the photographing lens (41) is exposed through a lens hole (15) which is formed in a central deep part of the front plate (11) and, acoustic sensors of the MEMS microphones (20) are preferably exposed through the plural of sensing holes (13) which are formed in the front plate (11).

12. A method of manufacturing a portable sound source searching sensor comprising:
a step (S10) of preparing a front body (10) having sensing holes (13) in a front plate (11) and a rear body (50) for protecting a substrate (30) in a pair of the front body (10);
a step (S30) of positioning the substrate (30), on which the MEMS microphones (20) are radially mounted, at a rear side of the front body (10) or at a front side of the rear body (50); and
an assembling step (S50) of coupling the front body (10) and the rear body (50) by a coupling means, and of integrating the front body (10), the substrate (30) and the rear body (50).

13. The method of claim 12 further comprising a step (S35) of positioning a photographing lens (41) in a lens hole (15) after the preparation step (S10) and before the assembling step (S50).

14. The method of claim 12, wherein a front surface of the rear body (50) is curved, and a flat rear inner plate (55) is coupled thereto.

15. The method of claim 12, wherein first hollow fixing pieces (18) are projected at a rear side of the front body (10), and second hollow fixing pieces (58) are projected at a front side of the rear body (50), and in the assembling step (S50), a coupling means tightens the first hollow fixing pieces (18) and the second hollow fixing pieces (58) to integrate the front body (10) and the rear body (50).

16. The method of claim 15, wherein a metal piece (19), which a spiral is formed on an inner circumferential surface, is pressed and fixed in a hollow of the first hollow fixing piece (18), and the coupling means is a bolt or screw which penetrates the second hollow fixing pieces (58).

17. The method of claim 13, further comprising;
a step (S40) of positioning the image photographing unit (40) which processes image signal from the photographing lens (41) at a rear of the substrate (30) after the step of positioning the photographing lens S35 before the step of assembling S50; and
a step of electronically connecting (S45) the substrate (30) and a data acquisition board (70) for acquiring acoustic signal from the MEMS microphones (20) to pass it to a calculating unit.

18. The method of claim 12 further comprising a step of mounting a handle (60) which is projected backward of the rear body (50),
wherein the handle (60) is assembled from the start to a rear of the rear body (50) in the preparation step (S10), or the handle (60) is coupled to edge of the front body (10) or a rear side of the rear body (50) after the assembling step (S50).
